(19) United States
(12) Patent Application Publication
(10) Pub. No.: US 2019/0080690 A1
(43) Pub. Date: Mar. 14, 2019

(54) VOICE RECOGNITION DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Yusaku KIKUGAWA, Nishitama Tokyo (JP); Yasuyuki MASAI, Yokohama Kanagawa (JP); Keizo YAMASHITA, Yokohama Kanagawa (JP); Yasuhiro FUKUJU, Yokohama Kanagawa (JP)

(21) Appl. No.: 15/909,427

(22) Filed: Mar. 1, 2018

(30) Foreign Application Priority Data
Sep. 14, 2017 (JP) 2017-176742

(51) Int. Cl. G10L 15/20; G10L 15/22; G10L 17/00

(52) U.S. Cl. CPC G10L 15/20; G10L 17/005; G10L 15/22

(57) ABSTRACT

A voice recognition device includes a voice input unit that receives input sounds and converts the input sounds into voice signals and a voice trigger detector to detect a keyword in a voice signal from the voice input unit. A similarity calculator is provided to compare the voice signal to a reference audio signal, calculate a similarity between the reference audio signal and the voice signal, and output a signal indicating the calculated similarity.

### CROSS-REFERENCE TO RELATED APPLICATION

This application is based upon and claims the benefit of priority from Japanese Patent Application No. 2017-176742, filed Sep. 14, 2017, the entire contents of which are incorporated herein by reference.

### FIELD

Embodiments described herein relate generally to a voice recognition device.

### BACKGROUND

In the voice recognition device technology of the related art, a voice trigger process limits the number of keywords registered for voice commands to increase detection speed or detection sensitivity. Since a voice recognition technology is still used in the voice trigger process, there are still cases in which an erroneous detection occurs and a response or reaction is provided by a device even though the previously registered keyword is supplied from a television, a radio, or the like rather than an intended operator of the device.

In order to reduce the erroneous detection of this type, a method for inputting the sounds that are output from a voice output device (for example, a speaker) and then suppressing peripheral speaker-output sounds using an echo canceller and a method for determining an erroneous trigger detection by processing the possible voice triggers in parallel with the sound(s) output from the speaker and that are also input to a voice input device (for example, a microphone) are attempted. However, in a configuration in which an echo canceller is used, voices input to the microphone will also be distorted to some extent, and thus there is a possibility that detection accuracy for the voice trigger(s) will be deteriorated. In addition, in a configuration in which the voice trigger must be processed in parallel with speaker output sounds, a processing load for the voice trigger processing becomes substantially increased. A voice recognition device having reduced erroneous trigger detections without substantially increasing processor loads is desirable.

### DESCRIPTION OF THE DRAWINGS

FIG. 1 is a diagram illustrating a voice recognition device according to a first embodiment.

FIG. 2 is a flowchart illustrating a processing flow for reducing erroneous detection.

FIG. 3 is a diagram illustrating a voice recognition device according to a second embodiment.

FIG. 4 is a flowchart illustrating a processing flow for reducing erroneous detection.

FIG. 5 is a diagram illustrating a comparison of a duration of a voice signal and a duration of a keyword.

FIG. 6 is a diagram illustrating a voice recognition device according to a third embodiment.

FIG. 7 is a diagram illustrating a voice recognition device according to a fourth embodiment.

FIG. 8 is a diagram illustrating a voice recognition device according to a fifth embodiment.

### DETAILED DESCRIPTION

An exemplary embodiment provides a voice recognition device in which it is possible to reduce erroneous detection of a voice trigger keyword or the like.

In general, according to one embodiment, a voice recognition device, includes a voice input unit that receives input sounds and converts the input sounds into voice signals, a voice trigger detector configured to detect a keyword in a voice signal from the voice input unit, and a similarity calculator configured to compare the voice signal to a reference audio signal, calculate a similarity between the reference audio signal and the voice signal, and output a signal indicating the calculated similarity.

Voice recognition devices according to various example embodiments will be described with reference to the accompanying drawings. These example embodiments are merely some particular examples and the present disclosure is not limited to these particular example embodiments.

### First Embodiment

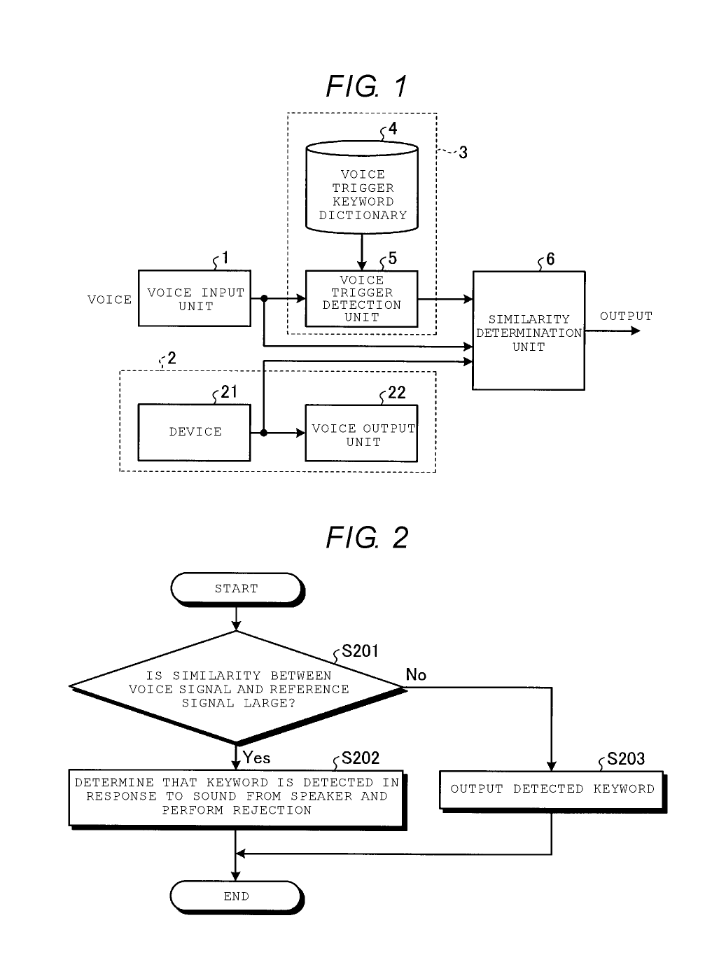

FIG. 1 is a diagram illustrating a configuration of a voice recognition device according to a first embodiment. The voice recognition device according to the first embodiment includes a voice input unit 1. The voice input unit 1 includes, or may be, for example, a microphone that converts voice sounds into corresponding electrical signals and outputs these electrical signals as voice signals. Also, in addition to voices, other sounds such as those of a musical instrument or the like may be input to the voice input unit 1. In such cases, the voices and the sounds are converted into electrical signals, and the resulting signals are output. Accordingly, though the electrical signals from output from the voice input unit 1 may be referred to as “voice signals” for convenience of description, the term “voice signals” as used herein includes a wider concept in which any input sounds (whether human voice, musical instrument, and/or other sound generator) are converted into electrical signals by the voice input unit 1.

The voice signals from the voice input unit 1 are supplied to a voice trigger processing unit 3, also referred to as voice trigger processor 3, and a similarity determination unit 6, also referred to as a similarity calculator 6. The voice trigger processing unit 3 includes a keyword dictionary 4 and a voice trigger detection unit 5, also referred to as a voice trigger detector 5.

Pieces of keyword information registered in the keyword dictionary 4 are supplied to the voice trigger detection unit 5. In the voice trigger detection unit 5, the voice signals are compared to the pieces of keyword information. In a case where a voice signal that is considered to coincide with a keyword is detected or otherwise determined, the voice trigger detection unit 5 outputs the detected keyword to the similarity determination unit 6. Also, the output of the voice trigger detection unit 5 may be a predetermined identification (ID) code or the like corresponding to the detected keyword. The keyword dictionary 4 comprises, for example, storage such as a Random Access Memory (RAM).

The keywords registered in the keyword dictionary 4 are not limited to voice sounds corresponding to a so-called discrete word such as “house”, “right”, and “left”, but may correspond to a longer phrase such as “go to the right”. In addition, the keyword information may correspond to such things as registered sounds like the sound of handclapping or the sounds of a specific instrument.

A voice signal from a voice output device 2, which includes a voice output unit 22, is supplied to the similarity determination unit 6 as a reference signal. The voice output device 2 is, for example, an electronic device, such as a car navigation system, a personal computer, or an audio reproduction device, which incorporates the voice output unit 22 that outputs voices or the like. A voice signal generated in a sound generator device 21 of the voice output device 2 is supplied to the voice output unit 22 for output as audible sounds or the like. The voice output unit 22 may be or comprise, for example, a speaker unit. There is a case in which the voice output device 2 becomes a control target of a voice trigger process according to an output from the voice trigger processing unit 3.

The supplied reference signal is an electrical signal, such as an electronic audio signal or the like, and is supplied directly to the similarity determination unit 6 as an electrical signal (that is, the output from sound generator device 21 is not transformed in to an acoustic signal before for supplying to similarity determination unit 6). The similarity determination unit 6 determines the similarity between the voice signal from the voice input unit 1 and the reference signal (from the voice output device 2). In general, the sound output by the voice output unit 22 is not particularly intended to be supplied to the voice input unit 1, but the output from the voice output unit 22 may still be captured by the voice input unit 1. Therefore, when the reference signal is compared with the voice signal from the voice input unit 1, the similarity determination unit 6 is capable of accurately determining whether or not the voice signal includes a voice/sounds output from the output device 2.

The voice signal has a time sequence signal waveform. Accordingly, it is possible to determine the similarity between both the signals based on correlation between waveforms of the signals which are input to the similarity determination unit 6. For example, it is possible to determine the similarity between signals by comparing variations in amplitude of the voice signal or formant (prominent frequency bands) of the voice signal with that of the reference signal.

In a case where the similarity between both the signals is large, it can be determined that the voice signal from the voice input unit 1 includes a voice sound which was supplied from the voice output unit 22, that is, an inadvertent voice, and the similarity determination unit 6 outputs a result of the determination accordingly. It is possible to cancel a voice trigger process according to the output from the similarity determination unit 6. Therefore, it is possible to reduce the erroneous detection of a voice trigger.

Since the reference signal is output by the voice output unit 22 as sound, the similarity between the reference signal and any leaked voice signal from the voice input unit 1 will be high. Accordingly, it is possible to increase accuracy in the erroneous detection of the voice trigger.

FIG. 2 is a flowchart illustrating an example of a process flow for determining erroneous detection. The processing is performed in, for example, the voice recognition device of FIG. 1.

The similarity between the voice signal from the voice input unit 1 and the reference signal from the voice output device 2 is determined (S201). For example, the correlation between the waveforms of both the signals is compared. In a case where the similarity between both the signals is large (S201: Yes), it is determined that there is a high possibility that a voice output from a speaker unit associated with or included in the voice output unit 22 has been captured by the voice input unit 1 and the voice trigger can be rejected (S202).

In a case where the similarity between both the signals is not large (S201: No), the detected keyword is output (S203), and a voice trigger process can be performed. Also, a predetermined ID, which is provided to correspond to the detected keyword, may be output as result of a keyword detection.

By incorporating a step of determining the similarity between a voice signal from the voice input unit 1 and a reference signal from the voice output device 2, it is possible to reduce the erroneous detection of a voice trigger.

### Second Embodiment

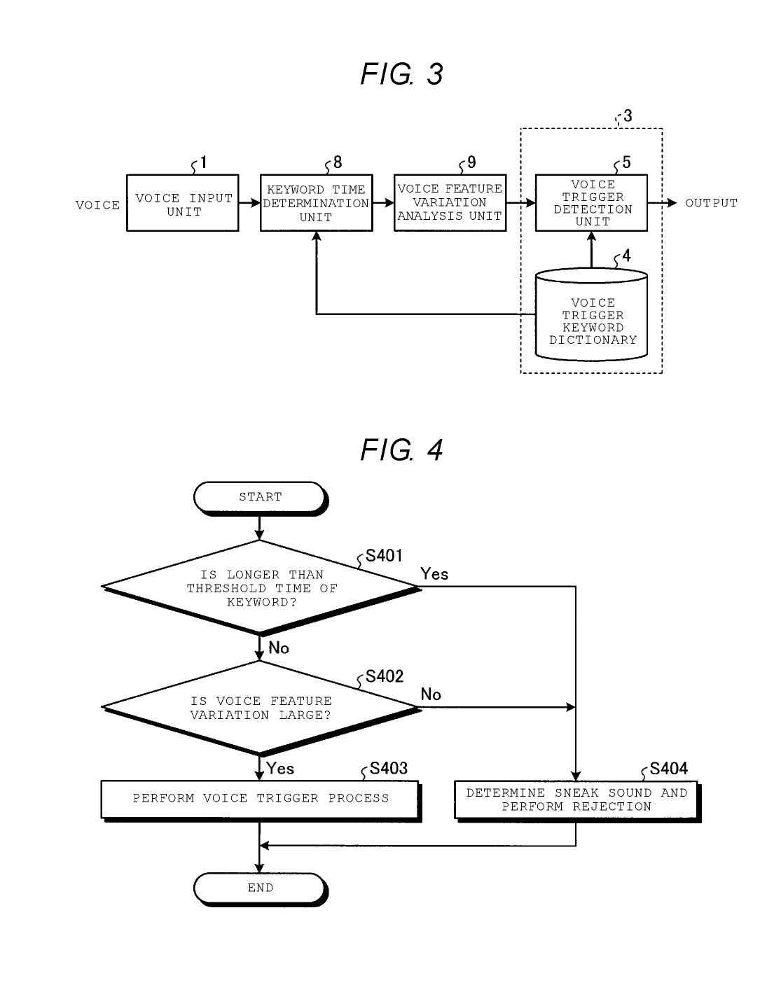

FIG. 3 is a diagram illustrating a configuration of a voice recognition device according to a second embodiment. The same reference symbols are used for repeated aspects corresponding to the first embodiment. The voice recognition device according to the second embodiment includes a voice input unit 1, a keyword time determination unit 8, a voice feature variation analysis unit 9, and a voice trigger processing unit 3.

Previously registered keywords are supplied to the keyword time determination unit 8 from a keyword dictionary 4. The keyword time determination unit 8, also referred to as keyword time comparator 8, helps detect whether or not a voice signal supplied from the voice input unit 1 includes a keyword. To determine that the voice signal includes a keyword, the keyword time determination unit 8 compares, for example, a duration of the voice signal to a duration of the keyword to determine if the duration of the voice signal meets or exceeds a threshold time.

In a case where the duration of the voice signal is longer than the threshold time corresponding to a keyword, it is determined that the voice signal is not a voice signal matching a voice command. That is, it is determined that the voice signal is inadvertently includes a keyword that has been supplied to the voice input unit 1.

When the total duration of the voice signal in which the keyword has been detected is longer than the threshold time for the keyword, there is a high possibility that the keyword was incidentally included in a non-command voice or sound. Accordingly, in a case where the duration of the voice signal in which the keyword is detected is compared with the threshold time of the keyword, it is possible to determine whether the detected keyword is a in a voice command or is incidentally included in a non-command voice.

For example, the voice signal output from the voice input unit 1 is stored in a storage device (not illustrated in the drawing), and its duration is determined by comparing the duration of the voice signal including the stored keyword to the detected threshold time when the voice signal which includes a keyword that is sensed.

An output signal from the keyword time determination unit 8 is supplied to the voice feature variation analysis unit 9, also referred to a voice feature variation analyzer 9. The output signal includes a signal, which indicates a result of determination performed by the keyword time determination unit 8, and the voice signal from the voice input unit 1.

In a situation in which the voice command that is input to the voice input unit 1 incidentally matches a sound input that includes the keyword at the same timing, for example, amplitude of the voice signal corresponding to the keyword increases. Accordingly, in a case where variation in a signal part corresponding to the keyword of the voice signal is analyzed and the variation is large, it is determined that a voice command was intentionally input.

In a case where the variation in the voice signal corresponding to the keyword is not large, it is determined that the keyword was incidentally captured, and a signal which causes the voice trigger process to be rejected is supplied to the voice trigger detection unit 5.

In the second embodiment, in a case where the duration of the voice signal which includes the keyword is compared with the threshold time of the registered keyword, it is possible to reduce the erroneous detection of the voice trigger commands/keywords. In addition, when it is determined by the voice feature variation analysis unit 9 whether or not a voice command including the keyword has been detected, it is further possible to reduce the erroneous detection of the voice trigger.

The determination in the keyword time determination unit 8 is performed to determine a length of time, and it is possible to perform a determination of long time (e.g., signal “1”) or a short time (e.g., signal “0”). Accordingly, a simpler configuration may be provided in which the voice feature variation analysis unit 9 is omitted and the voice trigger process is rejected based on only a determination performed by the keyword time determination unit 8.

FIG. 4 is a flowchart illustrating an example of a process flow for reducing the erroneous detection. The processing is performed in, for example, the voice recognition device of FIG. 3.

In a case where the voice signal output from the voice input unit 1 includes the registered keyword, the duration of the voice signal is compared to the threshold time of the keyword (S401). In a case where the duration of the voice signal is longer than the threshold time (S401: Yes), it is determined that the detected keyword is included in an inadvertent or incidental sound which was input to the voice input unit 1, and the voice trigger process is rejected (S404). The duration of the voice signal is compared with the threshold time of the keyword by the keyword time determination unit 8.

In a case where the duration of the voice signal is not longer than the threshold time (S401: No), a magnitude of the voice feature variation in the voice signal is determined (S402).

For example, in a case where the keyword matches the keyword of the voice command, the amplitude of the voice signal output by the voice input unit 1 can vary. In a case where the amplitude (or other voice feature) variation is large (S402: Yes), it is determined that the voice command has been input, and the voice trigger process is performed (S403).

In a case where voice feature variation in the voice signal is not large (S402: No), it is determined that the keyword was incidentally or otherwise included in the voice signal, and the voice trigger process is rejected (S404).

The voice signal from the voice input unit 1 can be stored, and variation in waveforms of the voice signals with a detected keyword can be observed. Therefore, it is possible to analyze a degree of the variation in the voice signal for a keyword. For example, a maximum value of the amplitude of the voice signal or variation in formant can be analyzed.

In a case where the duration of the voice signal, in which the keyword is detected, is compared with the threshold time of the registered keyword, it is possible to reduce the erroneous detection of the voice trigger.

In addition, in a case where a degree of the variation in a signal waveform of the voice signal is analyzed, it is possible thereby to determine whether a keyword in the voice signal corresponds to an intentional voice command or an inadvertently captured keyword mention. Therefore, it is possible to further reduce the erroneous detection of a voice trigger.

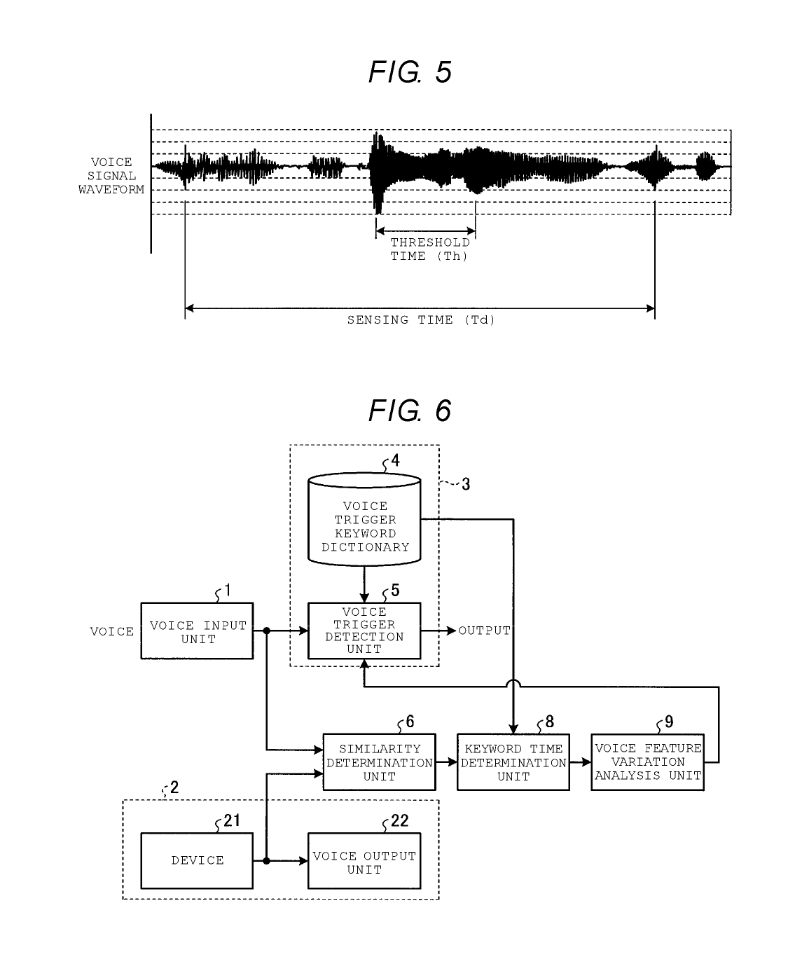

FIG. 5 is a diagram illustrating a comparison of a duration of a voice signal and a duration of a keyword. Here, the comparison is performed in the keyword time determination unit 8 depicted in FIG. 3.

In FIG. 5, threshold time (Th) indicates the duration of a registered keyword. Sensing time (Td) indicates the duration of a voice signal in which the registered keyword was detected. In a case where the sensing time (Td) is longer than the threshold time (Th), it is possible to determine that the detected keyword may have been incidentally included in the voice signal waveform.

Instead of a duration of a particular registered keyword, the maximum time which is allowable or acceptable as the duration of a keyword may be appropriately set as the threshold time (Th). In addition, in a case where the keyword is incidentally included in the voice signal, a determination may be performed by comparing the remaining duration of the voice signal after the keyword has been detected to the threshold time of a registered keyword.

In some examples, a voice recognition device may be formed by appropriately combining the similarity determination unit 6 according to the first embodiment with the keyword time determination unit 8 and the voice feature variation analysis unit 9 according to the second embodiment.

### Third Embodiment

FIG. 6 is a diagram illustrating a configuration of a voice recognition device according to a third embodiment. The same reference symbols are used for repeated components corresponding to the above-described embodiments. The voice recognition device according to the third embodiment includes a keyword time determination unit 8 and a voice feature variation analysis unit 9 in addition to a similarity determination unit 6.

That is, the voice recognition device according to the third embodiment has a configuration in which the keyword time determination unit 8 and the voice feature variation analysis unit 9 is added in series to the voice recognition device depicted in FIG. 1.

In a case where it is determined that the similarity between the voice signal from the voice input unit 1 and the reference signal from the voice output device 2 is not large in the similarity determination unit 6, the keyword time determination unit 8 then compares the duration of the voice signal with a threshold time of the keyword.

In a case where the duration of the voice signal is longer than the threshold time, it is determined that the voice signal from the voice input unit 1 inadvertently or incidentally included a keyword sound, and thus it is possible to reject the voice trigger process.

That is, even in a case where the similarity between the voice signal and the reference signal is not large, it is still possible to further reduce the erroneous detection of the voice trigger by comparing the duration of the voice signal with the threshold time of the keyword.

In addition, in a case where the voice feature variation in a voice signal which includes the keyword is not large, the voice feature variation analysis unit 9 determines that the detected keyword is included incidentally, and thus it is possible to reject the voice trigger process. Furthermore, it is possible to reduce the erroneous detection of the voice trigger.

### Fourth Embodiment

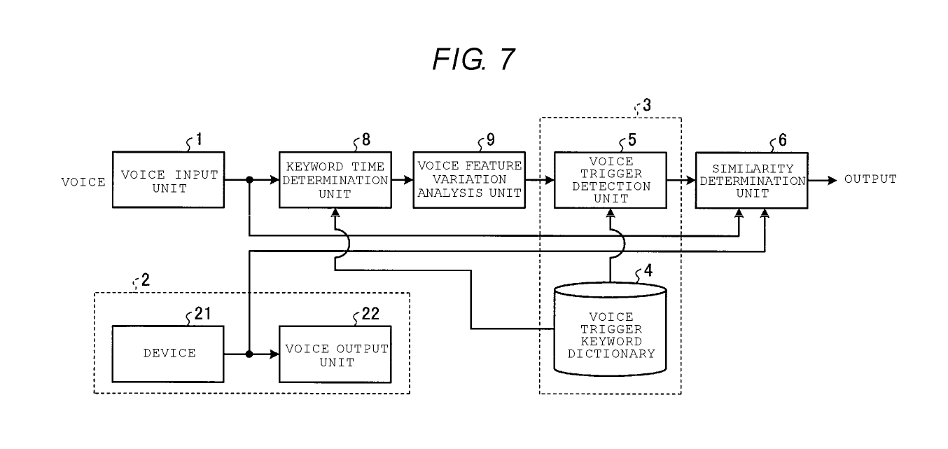

FIG. 7 is a diagram illustrating a configuration of a voice recognition device according to a fourth embodiment. The same reference symbols are used for repeated components corresponding to the above-described embodiments. The voice recognition device according to the fourth embodiment includes a similarity determination unit 6 in addition to a keyword time determination unit 8 and a voice feature variation analysis unit 9.

That is, the voice recognition device according to the fourth embodiment has a configuration in which the similarity determination unit 6 is added in series to the configuration of the voice recognition device depicted in FIG. 3.

The keyword time determination unit 8 compares the duration of the voice signal with the threshold time of the keyword, the voice feature variation analysis unit 9 analyzes the amplitude of a variation of the voice signal, and, furthermore, the similarity determination unit 6 determines the similarity between the voice signal and a reference signal.

In a case where the duration of the voice signal is within a threshold time for a keyword or in a case where the feature variation in the voice signal detected is large, it is determined that the keyword included in the voice signal is included inadvertently even in a case where the similarity between the voice signal and the reference signal is large, and thus it is possible to reject the voice trigger process. Therefore, it is possible to further reduce the erroneous detection of the voice trigger.

### Fifth Embodiment

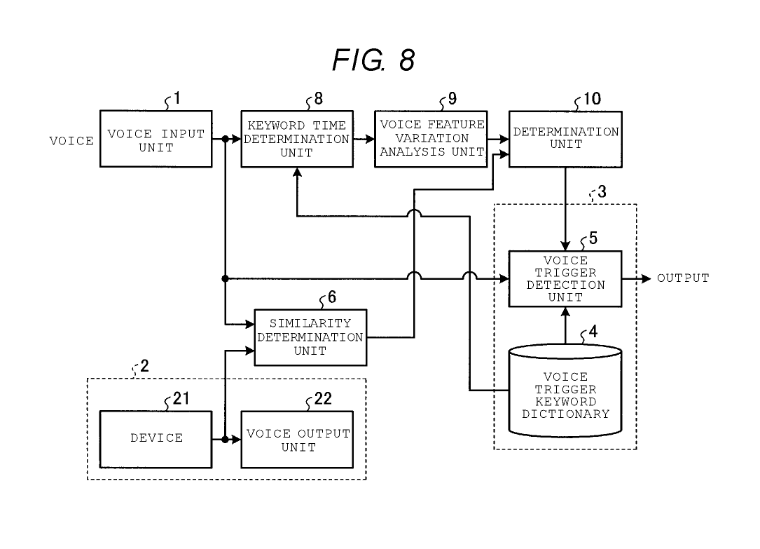

FIG. 8 is a diagram illustrating a configuration of a voice recognition device according to a fifth embodiment. The voice recognition device according to the fifth embodiment includes the configuration depicted in FIG. 1, the configuration depicted . 3, and further includes a determination unit 10 which comprehensively evaluates a result of detection.

In general, the similarity determination unit 6 provides very few results for which similarity does not exist at all (similarity determination “0”) and very few results for which the voice signal completely matches (similarity determination “1”) to the reference signal, and the established similarity between the voice signal and the reference signal might be indicated, for example, as “large similarity,” “medium similarity,” and “small similarity.” In addition, the voice feature variation analysis unit 9 provides an output result determination that is likewise rarely a definite yes/no outcome but rather reflects varying degrees of similarity.

However, the comparison of the threshold time performed by the keyword time determination unit 8 provides a substantially definite, “yes/no” result according to the threshold time. In contrast, the voice feature analysis performed by the voice feature variation analysis unit 9 will generally be a non-binary result reflecting some degree of similarity in the comparison.

The determination unit 10 may take as inputs the various results from the different units such as the results from the similarity determination unit 6, the results from the keyword time determination unit 8, and results from the voice feature variation analysis unit 9 in making a comprehensive determination as to whether a keyword is included in the voice signal. For example, when a determination to reject the voice trigger process is unanimously made according to the three different units, the determination unit 10 determines to cancel the voice trigger process accordingly.

In contrast, in a case where the results of the determination from three different units are different or point to different conclusions, it is possible to give decisive priority to any one of the determination results of three units. For example, it is possible to make a configuration in which priority is given to the result of the similarity determination against the reference signal by the similarity determination unit 6.

Otherwise, a configuration can be adopted in which the voice trigger process is rejected in a case in which two of the three different units indicate rejection/cancellation of a trigger process should be made. Likewise, results from each of the different units might be evaluated against predetermined reference values or threshold levels to improve the accuracy in the detection of the voice trigger.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A voice recognition device, comprising:
a voice input unit that receives input sounds and converts the input sounds into voice signals;
a voice trigger detector configured to detect a keyword in a voice signal from the voice input unit; and
a similarity calculator configured to compare the voice signal to a reference audio signal, calculate a similarity between the reference audio signal and the voice signal, and output a signal indicating the calculated similarity.

2. The voice recognition device according to claim 1, further comprising:
a keyword time comparator configured to compare a duration time for the voice signal to a threshold duration time for the keyword and output a signal indicating whether the duration time of the voice signal exceeds the threshold duration time.

3. The voice recognition device according to claim 2, further comprising:
a voice feature variation analyzer that analyzes an amount of variation in the voice signal and outputs a signal corresponding to the amount of variation in the voice signal.

4. The voice recognition device according to claim 1, further comprising:
a voice feature variation analyzer that analyzes an amount of variation in the voice signal and outputs a signal corresponding to the amount of variation in the voice signal.

5. The voice recognition device according to claim 1, further comprising:
a storage device storing a plurality of pre-registered keywords, wherein
the voice trigger detector is further configured to detect any of the pre-registered keywords as the keyword in the voice signal from the voice input unit.

6. The voice recognition device according to claim 5, further comprising:
a keyword time comparator configured to compare a duration time for the voice signal to a threshold duration time for the keyword and output a signal indicating whether the duration time of the voice signal exceeds the threshold duration time, wherein
the storage device further stores threshold duration times for each of the pre-registered keywords.

7. The voice recognition device according to claim 1, wherein the voice input unit comprises a microphone.

8. The voice recognition device according to claim 1, wherein the voice trigger detector is further configured to output a signal only when the keyword is detected in the voice signal.

9. The voice recognition device according to claim 8, wherein the signal output by the similarity calculator is only output if the signal from the voice trigger detector is output.

10. An electronic device, comprising:
an audio signal generating device generating an electronic audio signal;
an audio output unit providing an audible output according to the electronic audio signal; and
a voice recognition device according to claim 1, wherein the electronic audio signal is the reference audio signal.

11. A voice recognition device, comprising:
a voice input unit that receives input sounds and converts the input sounds into voice signals;
a voice trigger detector configured to detect a keyword in a voice signal from the voice input unit; and
a keyword time comparator configured to compare a duration time for the voice signal to a threshold duration time for the keyword and output a signal indicating whether the duration time of the voice signal exceeds the threshold duration time.

12. The voice recognition device according to claim 11, further comprising:
a voice feature variation analyzer that analyzes an amount of variation in the voice signal and outputs a signal corresponding to the amount of variation in the voice signal.

13. The voice recognition device according to claim 12, further comprising:
a similarity calculator configured to compare the voice signal to a reference audio signal, calculate a similarity between the reference audio signal and the voice signal, and output a signal indicating the calculated similarity.

14. The voice recognition device according to claim 11, further comprising:
a similarity calculator configured to compare the voice signal to a reference audio signal, calculate a similarity between the reference audio signal and the voice signal, and output a signal indicating the calculated similarity.

15. The voice recognition device according to claim 11, further comprising:
a storage device storing a plurality of pre-registered keywords, wherein
the voice trigger detector is further configured to detect any of the pre-registered keywords as the keyword in the voice signal from the voice input unit.

16. The voice recognition device according to claim 11, wherein the voice trigger detector is further configured to output a signal only when the keyword is detected in the voice signal.

17. The voice recognition device according to claim 11, wherein the voice signal is supplied to keyword time comparator directly from the voice input unit and the voice trigger detector receives the voice signal only if the duration time of the voice signal is less than the threshold duration time for the keyword.

18. An electronic device, comprising:
an audio signal generating device generating an electronic audio signal;
an audio speaker unit providing an audible output according to the electronic audio signal;
a microphone that receives input sounds and converts the input sounds into voice signals;
a voice trigger processing unit including:
a storage device storing a plurality of pre-registered keywords; and
a voice trigger detector configured to detect a keyword in a voice signal from the microphone by comparison to plurality of pre-registered keywords; and
a similarity calculator configured to compare the voice signal received by the microphone to the electronic audio signal supplied directly from the audio signal generating device, calculate a similarity between the electronic audio signal and the voice signal from the microphone, and output a signal indicating the calculated similarity, wherein
the voice trigger processing unit outputs a trigger signal indicating the keyword has been detected only when the calculated similarity is below a threshold similarity value.

19. The electronic device according to claim 18, further comprising:
a keyword time comparator configured to compare a duration time for the voice signal to a threshold duration time for the keyword and output a signal indicating whether the duration time of the voice signal exceeds the threshold duration time.

20. The electronic device according to claim 18, further comprising:
a voice feature variation analyzer that analyzes an amount of variation in the voice signal and outputs a signal corresponding to the amount of variation in the voice signal.
